(19) United States
(12) Patent Application Publication
(10) Pub. No.: US 2024/0243420 A1
(43) Pub. Date: Jul. 18, 2024

(54) WIRING MODULE AND BUSBAR UNIT

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Nobuyuki MATSUMURA, Osaka (JP); Shinichi TAKASE, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/285,795

(22) PCT Filed: Mar. 22, 2022
(86) PCT No.: PCT/JP2022/013060

§ 371 Date: Oct. 5, 2023

(30) Foreign Application Priority Data
Apr. 22, 2021 (JP) 2021-072569

(51) Int. Cl. H01M 50/298; H01M 50/249; H01M 50/262; H01M 50/507; H01M 50/519; H01M 50/583

(52) U.S. Cl. CPC H01M 50/298; H01M 50/262; H01M 50/507; H01M 50/519; H01M 50/583; H01M 50/249; H01M 2220/20

(57) ABSTRACT

Provided is a wiring module configured to be attached to a plurality of power storage devices having electrode terminals. The wiring module includes: a plurality of busbar units: and wires connected to the busbar units. Each of the busbar units includes: a busbar connected to the electrode terminals; a circuit board, and a fixing means that fixes the circuit board to the busbar. A conductive path is routed on the circuit board, and the conductive path includes: a connection land electrically connected to the busbar; a wire land connected to the corresponding wire; and a chip fuse provided between the connection land and the wire land.

### TECHNICAL FIELD

The present disclosure relates to a wiring module and a busbar unit.

### BACKGROUND ART

Conventionally, in battery packs for use in electric automobiles, hybrid automobiles, and the like, a wiring module is electrically connected to a plurality of electric cells, the wiring module being for sensing voltages and the like of the electric cells. Such a wiring module may include a fuse for use in case of, for example, a short-circuit of electric cells. For example, the sensing module disclosed in JP 2016-115616A (see Patent Document 1 below) includes a fuse unit in which a busbar connection terminal connected to a busbar that connects electrode terminals of a plurality of electric cells, a wire connection terminal connected to a terminal part of a wire, and a fuse that connects the busbar connection terminal and the wire connection terminal are formed as one piece.

### CITATION LIST

### Patent Document

Patent Document 1: JP 2016-115616

### SUMMARY OF INVENTION

### Technical Problem

In the above-described configuration, the fuse unit includes a synthetic resin housing that houses the busbar connection terminal, the wire connection terminal, and the fuse. Furthermore, the housing of the fuse unit is held by a resin protector made of a synthetic resin. When the fuse unit is formed in the sensing module and is reinforced in this way, the number of components of the sensing module may increase, resulting in an increase in manufacturing cost.

### Solution to Problem

According to the present disclosure, a wiring module configured to be attached to a plurality of power storage devices having electrode terminals, the wiring module including: a plurality of busbar units: and wires connected to the busbar units, wherein each of the busbar units includes: a busbar connected to the electrode terminals; a circuit board, and a fixing means that fixes the circuit board to the busbar, a conductive path is routed on the circuit board, and the conductive path includes: a connection land electrically connected to the busbar; a wire land connected to the corresponding wire; and a chip fuse provided between the connection land and the wire land.

### Advantageous Effects of Invention

According to the present disclosure, it is possible to provide a wiring module that enables a simplified configuration and a reduced manufacturing cost.

### BRIEF DESCRIPTION OF DRAWINGS

FIG. 1 is a schematic view illustrating a vehicle on which a power storage module according to an embodiment is mounted.

FIG. 2 is a partially enlarged plan view of the power storage module.

FIG. 3 is an enlarged plan view of the power storage module illustrating a hard board.

FIG. 4 is an enlarged perspective view of the power storage module illustrating the hard board.

FIG. 5 is a cross-sectional view taken along a line A-A in FIG. 3.

FIG. 6 is an enlarged plan view of the power storage module illustrating a flexible board.

FIG. 7 is an enlarged perspective view of the power storage module illustrating the flexible board.

FIG. 8 is a cross-sectional view taken along a line B-B in FIG. 6.

FIG. 9 is a plan view of the hard board illustrating a sealing part.

FIG. 10 is a cross-sectional view taken along a line C-C in FIG. 9.

FIG. 11 is a perspective view of the hard board.

FIG. 12 is a perspective view of the flexible board.

FIG. 13 is a partially enlarged perspective view of a busbar to which the hard board is fixed.

FIG. 14 is a partially enlarged perspective view of a busbar to which the flexible board is fixed.

### DESCRIPTION OF EMBODIMENTS

### Description of Embodiments of Present Disclosure

First, embodiments of the present disclosure will be listed and described.

(1) According to the present disclosure, a wiring module configured to be attached to a plurality of power storage devices having electrode terminals includes: a plurality of busbar units: and wires connected to the busbar units, wherein each of the busbar units includes: a busbar connected to the electrode terminals; a circuit board; and a fixing means that fixes the circuit board to the busbar, a conductive path is routed on the circuit board, and the conductive path includes: a connection land electrically connected to the busbar; a wire land connected to the corresponding wire; and a chip fuse provided between the connection land and the wire land.

With this configuration, since the circuit board is fixed to the busbar, it is possible to reinforce the chip fuse on the circuit board with the busbar, eliminating the need of providing a member for protecting the chip fuse. Accordingly, it is possible to realize a simplified configuration of the wiring module and reduce the manufacturing cost of the wiring module.

(2) Preferably, the busbar has a first fixation hole, the circuit board has a second fixation hole, the fixing means is a rivet made of metal, the rivet includes a shaft portion inserted into the first fixation hole and the second fixation hole, and a head portion that is formed at an end of the shaft portion and has a diameter greater than hole diameters of the first fixation hole and the second fixation hole, and the circuit board has an insulation hole for increasing a creepage distance between the rivet and the conductive path.

With this configuration, it is possible to fix the circuit board to the busbar with the rivet. Also, since the circuit board has the insulation hole, the conductive path and the busbar are prevented from short-circuiting via the rivet in response to melting of the chip fuse.

(3) Preferably the circuit board has a drainage hole capable of discharging water attached to the circuit board.

With this configuration, the conductive path is prevented from short-circuiting via water on the circuit board.

(4) Preferably, the connection between the chip fuse and the conductive path is sealed by a sealing part made of a curable insulating resin, and the circuit board has a resin retaining hole for preventing the curable insulating resin that has not yet been cured and is liquid from spreading over the circuit board.

With this configuration, the sealing part prevents the conductive path from short-circuiting via water on the circuit board. Also, since the circuit board has the resin retaining hole, the uncured liquid insulating resin enters the resin retaining hole, and thus is unlikely to spread over the circuit board.

(5) Preferably, the busbar includes a crimping part that fixes the corresponding wire.

With this configuration, it is possible to fix the wire to the busbar with the crimping part.

(6) Preferably, the circuit board has a cutout for preventing the circuit board from interfering with the crimping part.

With this configuration, it is possible to prevent a short-circuit between the conductive path and the busbar.

(7) Preferably, the circuit board of at least one of the busbar units is a hard board.

With this configuration, it is possible to improve the strength of the circuit board. Also, it is possible to reduce the manufacturing cost of the wiring module.

(8) Preferably, the circuit board of at least one of the busbar units is a flexible board.

With this configuration, it is possible to realize a flexible circuit board. Also, it is possible to realize a thin circuit board.

(9) Preferably, the flexible board includes a thermistor circuit.

With this configuration, it is possible to measure the temperature of the power storage devices using the thermistor circuit.

(10) The above-described wiring module is a vehicular wiring module to be electrically attached to the plurality of power storage devices mounted on a vehicle.

(11) According to the present disclosure, a busbar unit configured to be electrically connected to power storage devices having electrode terminals and to a wire includes: a busbar connected to the electrode terminals; a circuit board; and a fixing means that fixes the circuit board to the busbar, wherein a conductive path is routed on the circuit board, and the conductive path includes: a connection land electrically connected to the busbar; a wire land connected to the wire; and a chip fuse provided between the connection land and the wire land.

### Detail of Embodiments of Present Disclosure

The following will describe embodiments of the present disclosure. The present disclosure is not limited to the examples but is indicated by the claims, and is intended to include all modifications within the meaning and scope equivalent to the claims.

### Embodiments

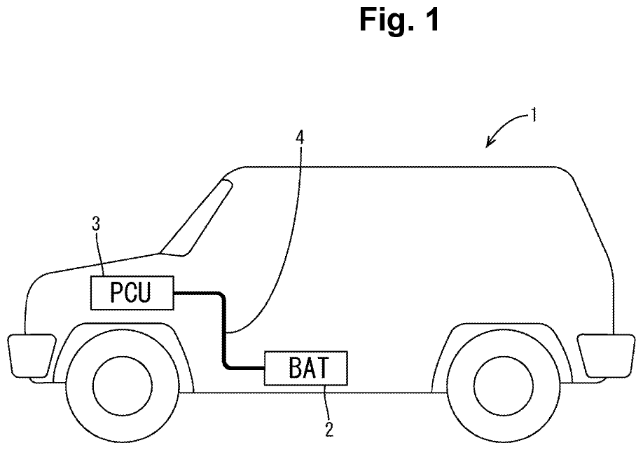

The following will describe embodiments of the present disclosure with reference to FIGS. 1 to 14. A power storage module 10 including a wiring module 20 according to the present embodiment is applied to, for example, a power storage pack 2 installed in a vehicle 1 as shown in FIG. 1. The electric storage pack 2 is installed in the vehicle 1 such as an electric automobile or a hybrid automobile, and is used as a drive source of the vehicle 1. In the following description, there are sometimes cases where reference numerals are added only to some of a plurality of members, and the reference numerals for the remaining members are omitted.

As shown in FIG. 1, the power storage pack 2 is disposed near the center of the vehicle 1. A power control unit (PCU 3) is disposed in a front portion of the vehicle 1. The power storage pack 2 and the PCU 3 are connected to each other by a wire harness 4. The power storage pack 2 and the wire harness 4 are connected to each other by a not-shown connector. The power storage pack 2 includes the power storage module 10 provided with a plurality of power storage devices 11. The power storage module 10 (and the wiring module 20) can be installed in a suitable orientation, and will be hereinafter described with reference to the drawings except for FIG. 1, with the direction indicated by an arrow Z being defined as upward, the direction indicated by an arrow X being defined as forward, and the direction indicated by an arrow Y being defined as leftward.

### Power Storage Device and Electrode Terminal

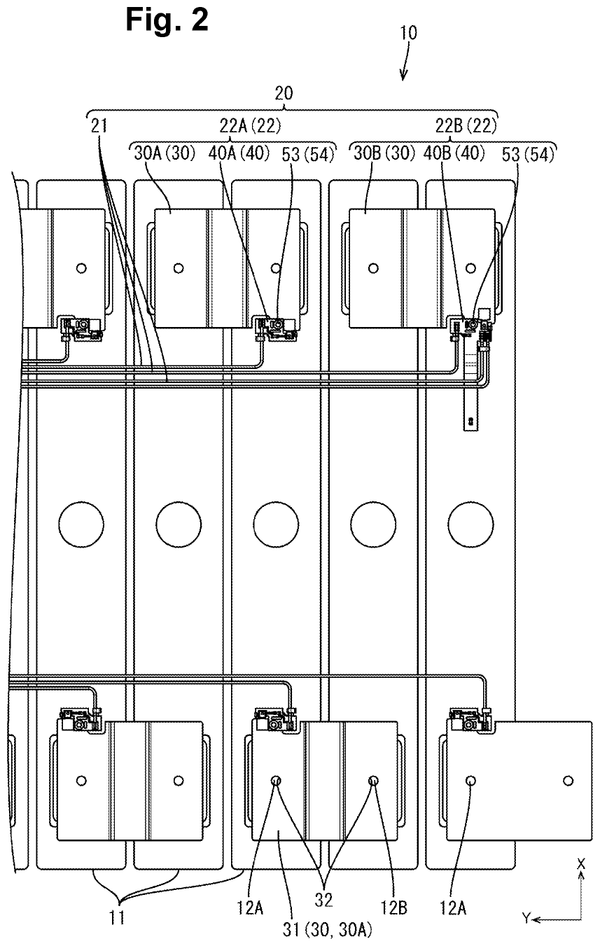

As shown in FIG. 2, the power storage module 10 includes the plurality of power storage devices 11 lined up in a left-right direction, and wiring modules 20 fitted to the upper surfaces of the plurality of power storage devices 11 (illustration of the left side portion of the power storage module 10 is omitted). The power storage devices 11 have a flat cuboidal shape. A not-shown power storage element is accommodated inside each of the power storage devices 11. The power storage devices 11 each include, on the upper surface thereof, electrode terminals 12A and 12B, which are positive and negative electrodes. The power storage devices 11 are not particularly limited, and may be secondary batteries or capacitors. The power storage devices 11 according to the present embodiment are secondary batteries.

### Wiring Module

As shown in FIG. 2, each wiring module 20 includes a plurality of busbar units 22, and wires 21 connected to the busbar units 22. The wiring module 20 is adopted to be attached to front portions or rear portions of the plurality of power storage devices 11. The following will describe in detail a configuration of the wiring module 20 disposed in the front portions of power storage devices 11. Note that, in the wiring module 20 disposed in the rear portions of power storage devices 11, both the front-rear direction and the left-right direction are inverted, but otherwise there is no difference in configuration between the wiring module 20 disposed in the front portions, and the wiring module 20 disposed in the rear portions.

### Busbar Unit

As shown in FIG. 2, the busbar unit 22 includes a busbar 30 connected to the electrode terminals 12A and 12B, a circuit board 40 that connects the busbar 30 to the wire 21, and a fixing means 53 that fixes the circuit board 40 to the busbar 30. More specifically, the wiring module 20 of the present embodiment includes two different types of busbar units 22A and 22B. The busbar unit 22A includes a busbar 30A and a circuit board 40A, and the busbar unit 22B includes a busbar 30B and a circuit board 40B. In the following description, if there is no need to distinguish the types of busbar units 22, busbars 30, and circuit boards 40, they are used without being distinguished from each other.

### Busbar

The busbar 30 is made of a conductive metal plate material. Examples of the metal of which the busbar 30 is made include copper, a copper alloy, aluminum, an aluminum alloy and stainless steel (SUS). As shown in FIG. 2, the busbar 30 includes a busbar body 31 in a rectangular shape in a plan view, and electrode insertion holes 32 passing through the busbar body 31 in an up-down direction. The electrode terminals 12A and 12B are inserted into the electrode insertion holes 32. The busbar 30 is welded and electrically connected to the electrode terminals 12A and 12B. The busbars 30 include a busbar 30 that connects the electrode terminals 12A and 12B of adjacent power storage devices 11, and a busbar 30 that is connected to all the positive electrodes or the negative electrodes of the plurality of power storage devices 11, but in the following, they are not distinguished from each other.

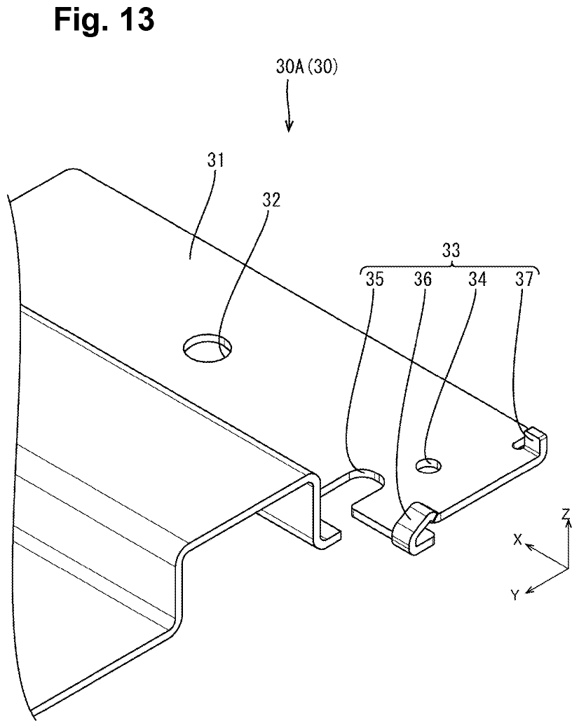

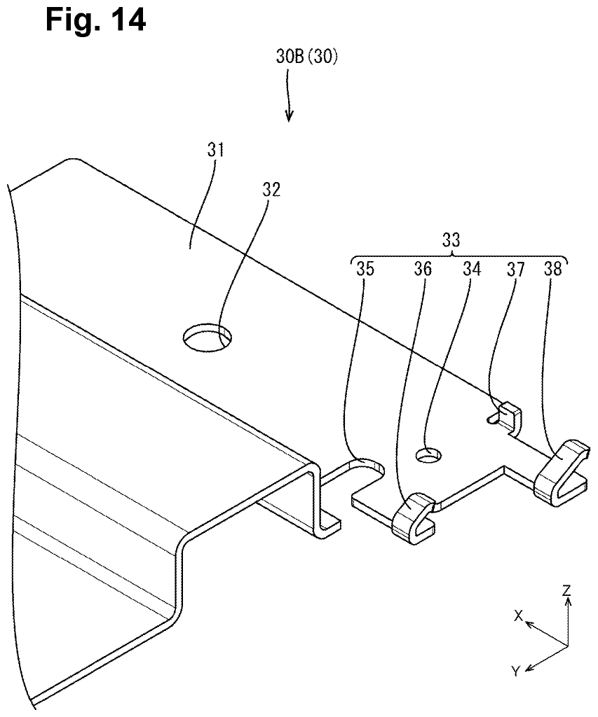

As shown in FIG. 2, for the busbar 30 arranged in the front portions of the plurality of power storage devices 11, the circuit board 40 is provided at the right rear corner, out of the four corners of the rectangular busbar 30. The busbars 30 of the present embodiment include the busbar 30A provided with the circuit board 40A, and the busbar 30B provided with the circuit board 40B. Hereinafter, the right rear corner portion of the busbar 30 in which the circuit board 40 is provided is defined as a circuit board arrangement portion 33 (see FIGS. 13 and 14).

### First Fixation Hole and Crimping Part

As shown in FIG. 13, the circuit board arrangement portion 33 of the busbar 30A includes: a first fixation hole 34 passing through the busbar 30A in the up-down direction; a recess 35 recessed inward from an outer edge portion of the busbar body 31; a crimping part 36 bent rightward; and a positioning projection 37 projecting upward. The first fixation hole 34 is located at almost the center of the circuit board arrangement portion 33. The recess 35 is formed on the left side of the circuit board arrangement portion 33, and is L-shaped. The crimping part 36 is provided behind the recess 35, and protrudes rearward from the busbar body 31. The positioning projection 37 is arranged at the right end of the circuit board arrangement portion 33.

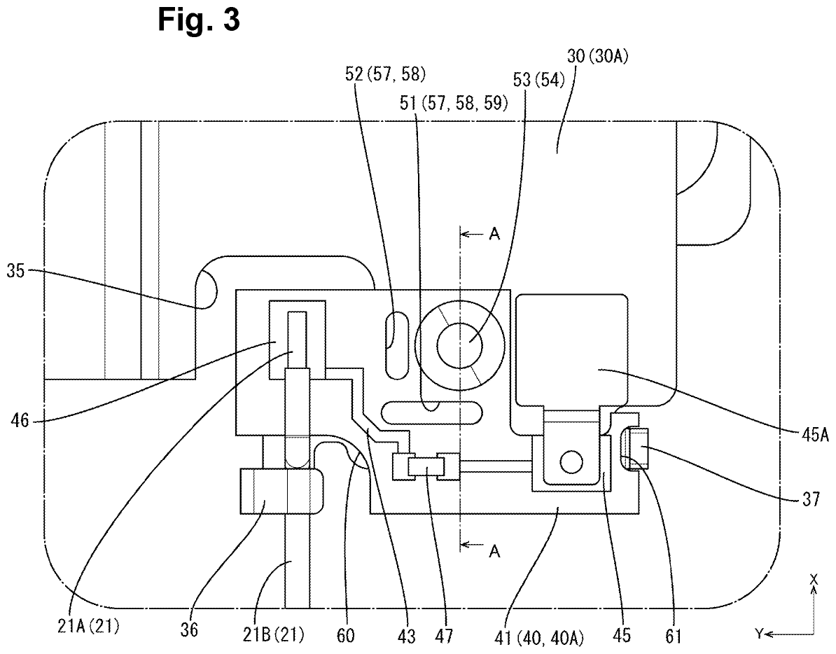

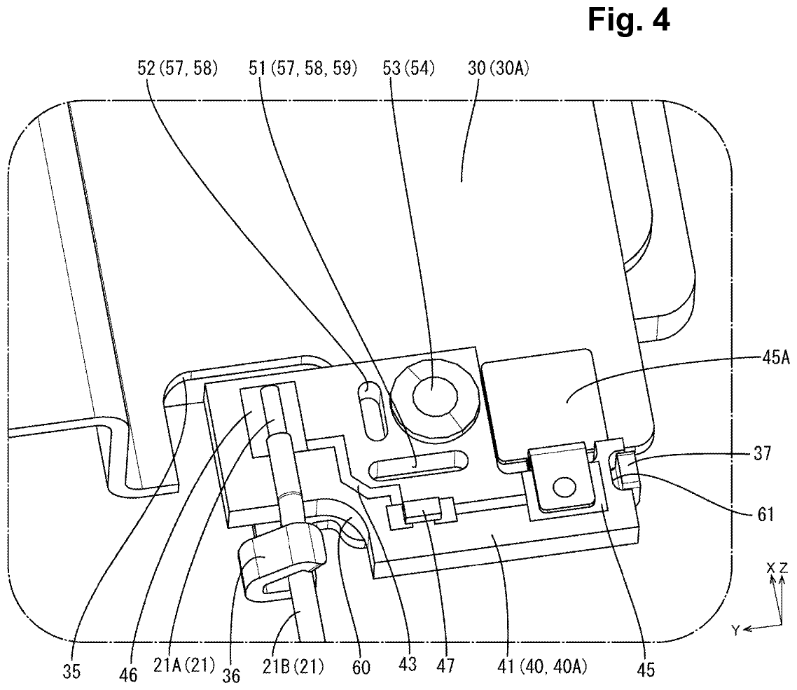

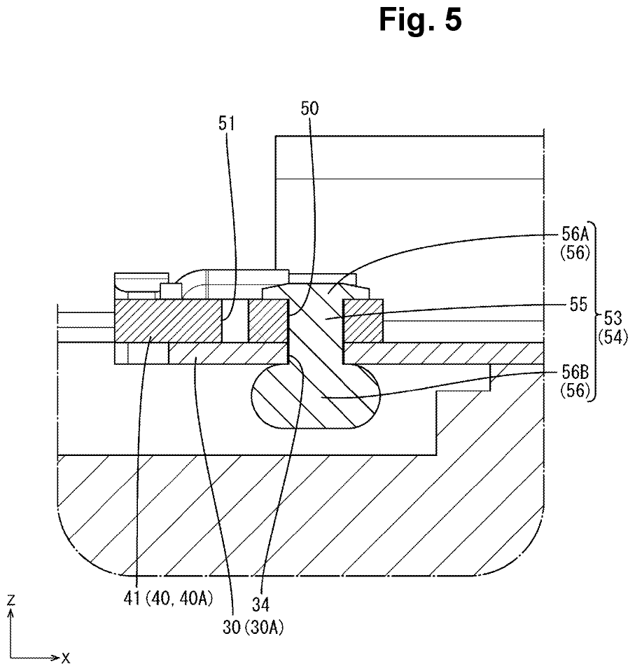

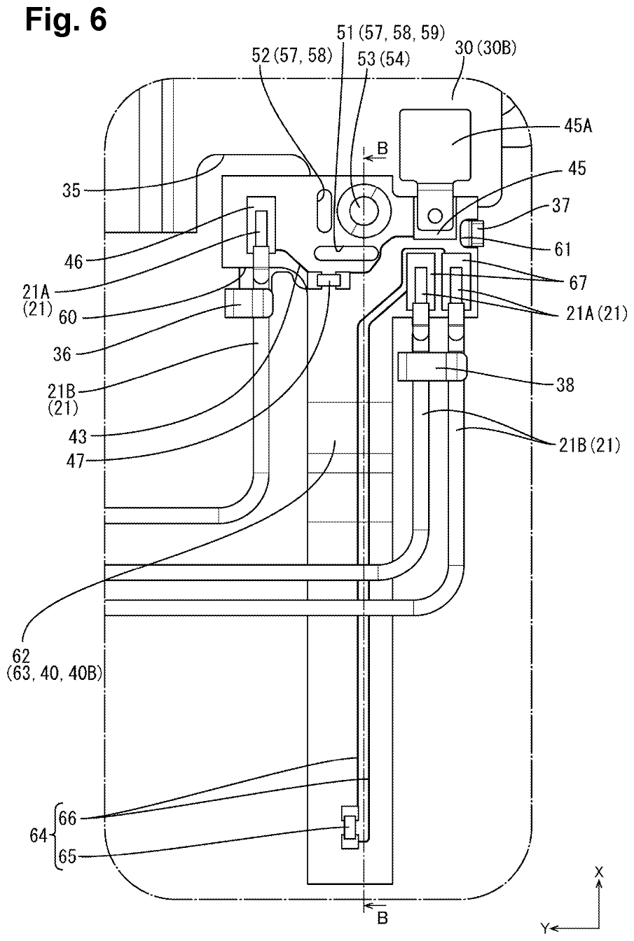

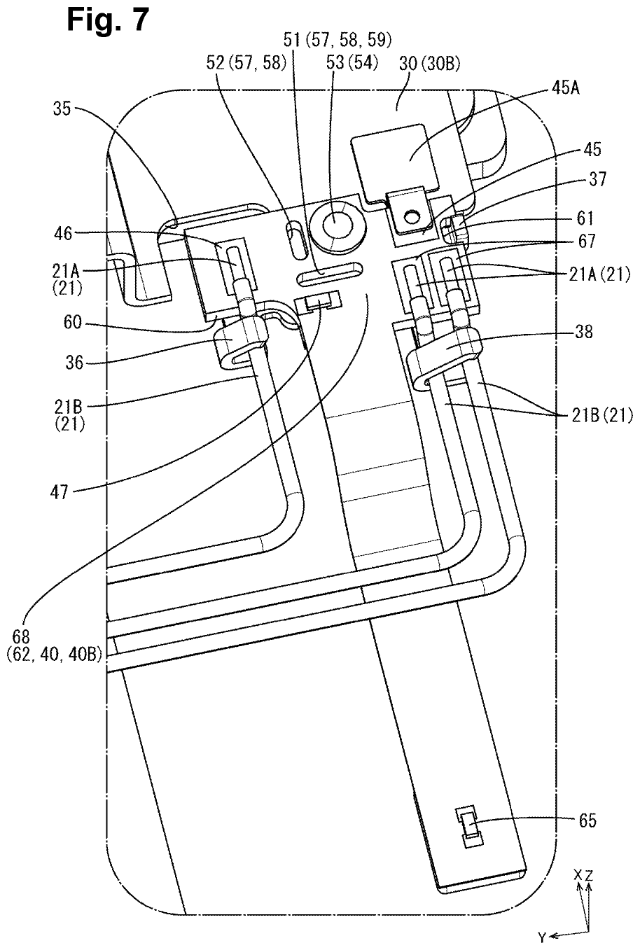

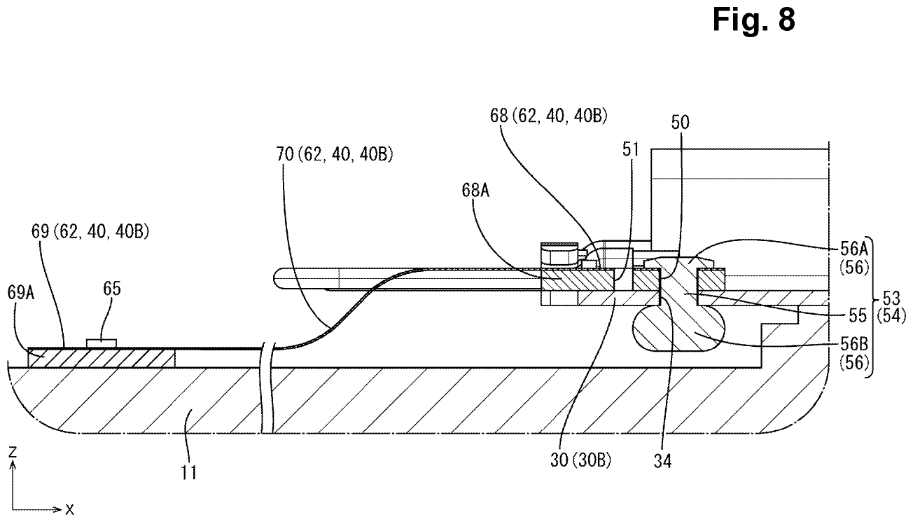

As shown in FIG. 14, the circuit board arrangement portion 33 of the busbar 30B has the same configuration as that of the circuit board arrangement portion 33 of the busbar 30A, and includes an additional crimping part 38 on the right side of the circuit board arrangement portion 33. As shown in FIGS. 5 and 8, the first fixation hole 34 is a hole into which a fixing means 53 (rivet 54) is inserted. As shown in FIGS. 4 and 7, the crimping part 36, 38 is configured to hold and fix at least one wire 21. The positioning projection 37 is received in a positioning recess 61 in the circuit board 40 to position the busbar 30 and the circuit board 40. As shown in FIGS. 3 and 6, the recess 35 is arranged in the surroundings of a wire land 46 of a conductive path 43. Accordingly the spatial distance between the busbar 30 and the wire land 46 is ensured, which prevents a short-circuit between the busbar 30 and the conductive path 43.

### Circuit Board

In the present embodiment, as shown in FIG. 2, two types of circuit boards 40, namely the circuit board 40A and the circuit board 40B are provided. The following will describe a configuration of the circuit board 40A, and then a specific configuration of the circuit board 40B that is different from that of the circuit board 40A.

### Hard Board and Conductive Path

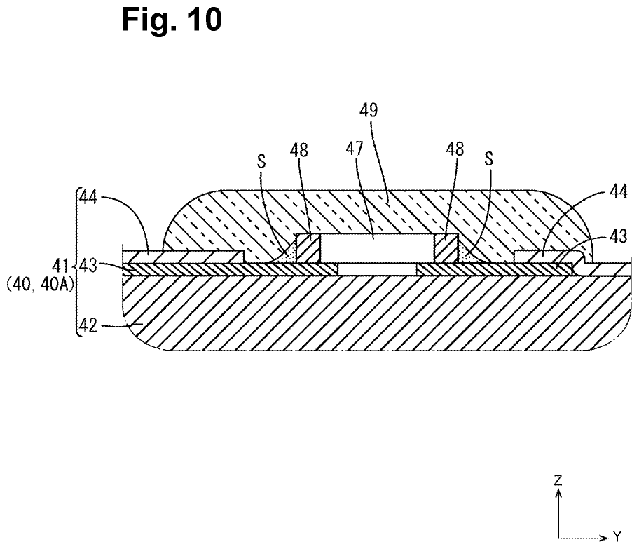

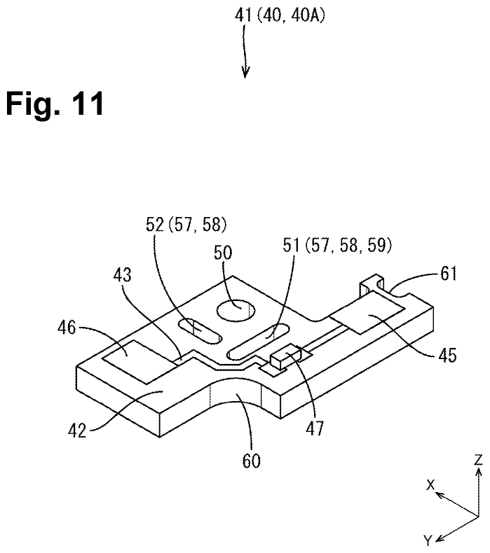

As shown in FIG. 11, the circuit board 40A is a hard board 41, and includes an insulating plate 42 having insulation properties, and the conductive path 43 formed on the insulating plate 42. The insulating plate 42 is formed, for example, by impregnating glass fiber cloth with an epoxy resin and curing the epoxy resin. The conductive path 43 is made of, for example, metal such as copper or a copper alloy and is conductive. Note that, as only shown in FIG. 10, the conductive path 43 is covered with an insulating layer 44 except for a portion that is soldered with a chip fuse 47 and the like. The insulating layer 44 is made of a synthetic resin such as polyimide. As shown in FIG. 11, the conductive path 43 includes a connection land 45 arranged at one end of the conductive path 43, the wire land 46 arranged at the other end of the conductive path 43, and the chip fuse 47 provided between the connection land 45 and the wire land 46.

### Connection Land and Wire Land

As shown in FIGS. 3 and 4, the connection land 45 is formed on the hard board 41 on the right side. The connection land 45 is electrically connected to the busbar 30 via a small metal piece 45A made of copper or the like. The connection land 45 and the small metal piece 45A are connected to each other by soldering, and the busbar 30 and the small metal piece 45A are connected to each other by welding. The wire land 46 is formed on the hard board 41 on the left side. The wire land 46 is connected to a core wire 21A of the wire 21 by soldering.

### Chip Fuse

As shown in FIG. 11, the chip fuse 47 is provided in the conductive path 43 at a position midway from the connection land 45 to the wire land 46. As shown in FIG. 10, the chip fuse 47 and portions of the conductive path 43 are connected to each other by solders S. Specifically, one of a pair of electrodes 48 of the chip fuse 47 is connected to the portion of the conductive path 43 on the connection land 45 side (left side in the drawing), and the other electrode 48 is connected to the portion of the conductive path 43 on the wire land 46 side (right side in the drawing).

### Sealing Part

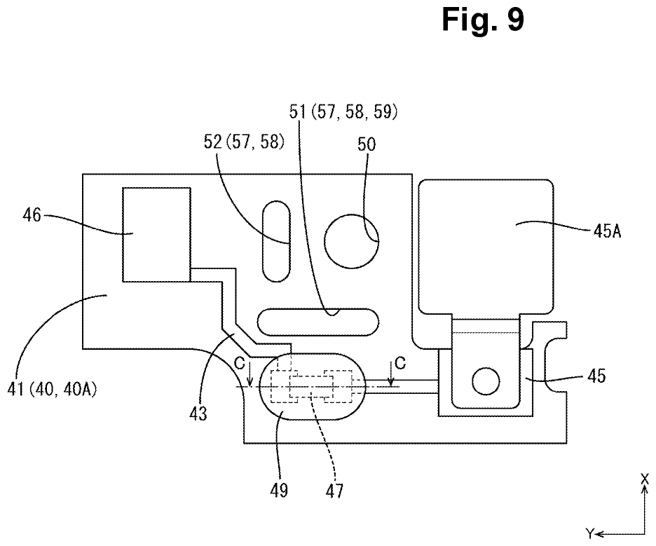

As shown only in FIGS. 9 and 10, the connection between the chip fuse 47 and the conductive path 43 is sealed by a sealing part 49. Here, as shown in FIG. 10, the connection between the chip fuse 47 and the conductive path 43 at least includes the entire chip fuse 47, the solders S, and end portions of the conductive path 43 that are connected to the electrodes 48 of the chip fuse 47 and are not covered with the insulating layer 44. The sealing part 49 is made of a curable insulating resin. The sealing part 49 is formed by applying an uncured liquid insulating resin to the hard board 41 so that the insulating resin covers the connection between the chip fuse 47 and the conductive path 43, and then curing the insulating resin.

As a result of the chip fuse 47 being provided, even if, due to a defect in an external circuit to which the power storage module 10 is connected, the portions of the conductive path 43 short-circuit and an overcurrent occurs, it will be possible to restrict the overcurrent from flowing from the power storage device 11 to the conductive path 43. Also, since the sealing part 49 covers the connection between the chip fuse 47 and the conductive path 43, it is possible to prevent a short-circuit of the conductive path 43 even if water drops or the like occur on the hard board 41 due to dew condensation.

### Second Fixation Hole

As shown in FIGS. 9 and 11, the hard board 41 has, on the front side of the central portion thereof in the left-right direction, a second fixation hole 50 that passes through the hard board 41 in the up-down direction. Behind the second fixation hole 50, a first through hole 51 is provided that passes through the hard board 41 in the up-down direction, and is in a long hole shape extending in the left-right direction. The first through hole 51 is formed between the second fixation hole 50 and the chip fuse 47. On the left side of the second fixation hole 50, a second through hole 52 is provided that passes through the hard board 41 in the up-down direction, and is in a long hole shape extending in the front-rear direction. The second through hole 52 is formed between the second fixation hole 50 and the wire land 46.

### Fixing Means, Rivet, Shaft Portion, and Head Portion

As shown in FIG. 5, the rivet 54, which is the fixing means 53 of the present embodiment, is inserted into the first fixation hole 34 and the second fixation hole 50, and the busbar 30 and the hard board 41 are fixed to each other by the rivet 54. The rivet 54 has a shaft portion 55 inserted into the first fixation hole 34 and the second fixation hole 50, and head portions 56 that are formed at ends of the shaft portion 55 and have diameters greater than the hole diameters of the first fixation hole 34 and the second fixation hole 50. The head portion 56 formed at the upper end of the shaft portion 55 is defined as an upper head portion 56A, and the head portion formed at the lower end of the shaft portion 55 is defined as a lower head portion 56B. The rivet 54 is made of metal since it requires to have a certain strength.

Although not shown, the rivet 54 before being fixed to the busbar 30 and the hard board 41 has the shaft portion 55 and the upper head portion 56A, and the lower head portion 56B is not formed. The lower head portion 56B is formed when the shaft portion 55 at which no lower head portion 56B is formed is inserted into the first fixation hole 34 and the second fixation hole 50, and is crimped.

### Insulation Hole and Drainage Hole

Since the rivet 54 is made of metal, the rivet 54 may have the same potential as that of the busbar 30, and may thus have a high voltage. In the present embodiment, as shown in FIGS. 3 and 4, the first through hole 51 and the second through hole 52 are formed while surrounding the rivet 54. Accordingly the first through hole 51 and the second through hole 52 increase the creepage distance between the rivet 54 and the conductive path 43, and prevent a short-circuit between the busbar 30 and the conductive path 43. Therefore, the first through hole 51 and the second through hole 52 function as insulation holes 57. Also, the first through hole 51 and the second through hole 52 function as drainage holes 58 for discharging water attached to the hard board 41 due to dew condensation.

### Resin Retaining Hole

Although not shown, during formation of the sealing part 49, when the uncured liquid insulating resin is applied to the connection between the chip fuse 47 and the conductive path 43 using a dispenser or the like, the insulating resin may spread over the hard board 41. In the present embodiment, since the first through hole 51 is formed as shown in FIG. 9, even if the insulating resin is spread to the front side of the chip fuse 47, the insulating resin will enter the first through hole 51, and will be prevented from reaching a portion of the hard board 41 located forward of the first through hole 51. Accordingly, the first through hole 51 functions as a resin retaining hole 59, which prevents an uncured liquid insulating resin from spreading over the hard board 41. Particularly since the resin retaining hole 59 is formed between the second fixation hole 50 and the chip fuse 47, the resin retaining hole 59 can prevent the insulating resin from reaching the hole edge of the second fixation hole 50.

### Cutout

As shown in FIGS. 3 and 4, a cutout 60 and a positioning recess 61 are provided in outer edge portions of the hard board 41, the cutout 60 and the positioning recess 61 being recessed inward from the outer edge portions. The cutout 60 is provided behind the wire land 46 and to the left of the chip fuse 47. The positioning recess 61 is provided to the right of the connection land 45. As a result of the cutout 60 being provided, it is possible to prevent the crimping part 36 and the hard board 41 from interfering with each other, while preventing a short-circuit between the busbar 30 and the conductive path 43. The positioning recess 61 receives the positioning projection 37 of the busbar 30, and positions the busbar 30 and the hard board 41.

### Wire

As shown in FIGS. 3 and 4, the wire 21 includes the core wire 21A, and an insulating coating 21B that covers the core wire 21A. The core wire 21A exposed from one end of the wire 21 is connected to the wire land 46 by soldering. The insulating coating 21B at one end of the wire 21 is fixed to the busbar 30 by the crimping part 36. As shown in FIGS. 6 and 7, the wires 21 connected to a later-described thermistor circuit 64 are also fixed to the crimping part 38. Although not shown, the ends of the wires 21 on the other side are connected to an external ECU (Electronic Control Unit) or the like via a connector. The ECU is a unit on which a microcomputer, elements, and the like are mounted, and has a well-known configuration having functions of, for example, sensing a voltage, a current, a temperature and the like of the power storage devices 11, and controlling charging/discharging of the power storage devices 11.

### Flexible Board

The circuit board 40B is a flexible board 62, and is a flexible printed board in the present embodiment. As shown in FIG. 6, the flexible board 62 of the present embodiment includes a base film 63, and the conductive path 43 and a thermistor conductive path 66 that are routed on a surface of the base film 63. Note that the entire conductive path 43 and the entire thermistor conductive path 66 are only shown in FIG. 6. Although not shown, the conductive path 43 and the thermistor conductive path 66 are covered with a coverlay film except for portions that are soldered to the chip fuse 47 and the like. The base film 63 and the coverlay film are made of a synthetic resin such as polyimide having insulation properties and flexibility. The conductive path 43 and the thermistor conductive path 66 are made of a foil of metal such as copper or a copper alloy.

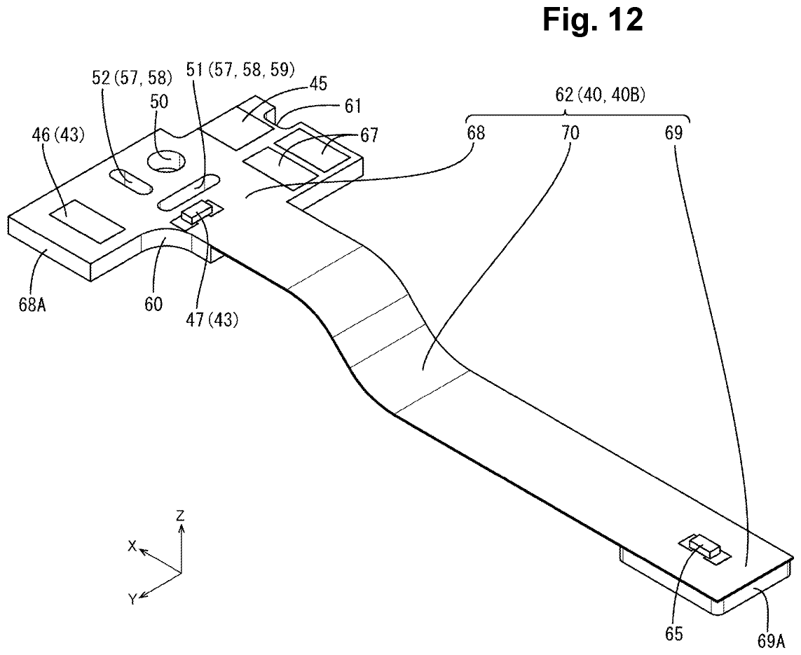

As shown in FIG. 12, the flexible board 62 includes: a reinforced portion 68 that is attached to a reinforcing plate 68A and is reinforced; a heat receiving portion 69 attached to a heat receiving plate 69A; and an extension portion 70 extending in the front-rear direction and coupling the reinforced portion 68 and the heat receiving portion 69. The reinforcing plate 68A is formed in the same fashion as the insulating plate 42 of the hard board 41. The reinforced portion 68 (and the reinforcing plate 68A) is (are) formed in substantially the same fashion as the hard board 41. Descriptions will be given using the same reference numerals for the components that are common between the reinforced portion 68 and the hard board 41. Note that the reinforcing plate 68A has holes that are respectively in communication with the second fixation hole 50, the first through hole 51, and the second through hole 52 in the reinforced portion 68 (the holes having the same reference numerals). As shown in FIG. 8, the reinforced portion 68 (and the reinforcing plate 68A) serves (serve) as a portion of the circuit board 40B that is fixed to the busbar 30B.

As shown in FIG. 12, the extension portion 70 is elongated, and extends rearward from the reinforced portion 68. The rear end of the coupling portion 70 is continuous to the heat receiving portion 69. Since the extension portion 70, which is a part of the flexible board 62, is flexible, and even if, as shown in FIG. 8, the reinforced portion 68 and the heat receiving portion 69 are shifted in the up-down direction, the extension portion 70 can smoothly connect the reinforced portion 68 and the heat receiving portion 69.

### Thermistor Circuit

The flexible board 62 differs from the hard board 41 in that the flexible board 62 includes the thermistor circuit 64. As shown in FIG. 6, the thermistor circuit 64 includes a thermistor 65 and the thermistor conductive path 66. A pair of electrodes (not shown) of the thermistor 65 are connected to the thermistor conductive path 66. The wire land 67 is formed at the end of the thermistor conductive path 66 opposite to the thermistor 65. As shown in FIG. 8, the thermistor 65 is an electronic component for measuring the temperature of the power storage devices 11, and is disposed on the heat receiving portion 69. The heat receiving portion 69 is disposed on the upper surface of the power storage device 11 via the heat receiving plate 69A. The heat receiving plate 69A is made of metal such as aluminum. As shown in FIG. 7, the wire land 67 is formed behind the connection land 45 of the reinforced portion 68, and is connected to the core wires 21A of the wires 21.

### Method for Manufacturing Busbar Unit and Wiring Module of the Present Embodiment

The following will describe an example of a method for manufacturing the busbar unit 22 and the wiring module 20 according to the present embodiment.

First, the circuit board 40 is manufactured using a printed wiring technique. The reinforcing plate 68A and the heat receiving plate 69A are attached to the circuit board 40B with an adhesive or the like. The chip fuse 47 and the small metal piece 45A are soldered to the circuit board 40 in a reflow process. Furthermore, the thermistor 65 is soldered to the circuit board 40B.

Then, the sealing part 49 that seals the chip fuse 47 is formed. An uncured liquid insulating resin is dropped onto the connection between the chip fuse 47 and the conductive path 43 on the circuit board 40 using a dispenser or the like, and is applied in a dome shape. Here, the insulating resin does not reach the hole edge of the second fixation hole 50 due to the resin retaining hole 59 (see FIG. 9), and thus a later operation of inserting the rivet 54 is not impaired. The applied insulating resin is cured by a well-known method. As a method for curing the insulating resin, a suitable method such as cooling, adding a curing agent, or irradiating light can be selected.

The circuit board 40 (see FIG. 9) on which the chip fuse 47 and the like are mounted, and the sealing part 49 is formed is fixed to the busbar 30 with the rivet 54. By inserting the shaft portion 55 into the first fixation hole 34 of the busbar 30 and the second fixation hole 50 of the circuit board 40, and crimping the shaft portion 55, the lower head portion 56B is formed. The rivet 54 after the lower head portion 56B has been formed is designed such that the dimension of the shaft portion 55 in the up-down direction matches the sum of the dimensions of the busbar 30 and the circuit board 40 in the up-down direction (see FIGS. 5 and 8). When fixing the circuit board 40 to the busbar 30, the circuit board 40 and the busbar 30 are positioned by the positioning projection 37 of the busbar 30 being received by the positioning recess 61 in the circuit board 40. Then, the small metal piece 45A and the busbar 30 are connected to each other by welding. With this, the manufacturing of the busbar unit 22 is complete.

Ultimately, the wire 21 is connected to the busbar unit 22. The insulating coating 21B of the wire 21 is fixed to the crimping part 36, 38, and then the core wire 21A of the wire 21 is soldered to the wire land 46, 67. With this, the manufacturing of the wiring module 20 is complete.

In the method of manufacturing the wiring module 20, the process of soldering the wire 21 to the busbar unit 22 is the last process. With this, it is possible to reduce the opportunities of handling the wire 21, which is elongated and hard to be routed. The busbar unit 22 that does not include any wire 21 and is easy to be handled is convenient for transport, for example. Also, the soldering the busbar unit 22 and the wire 21 may be performed at a factory which is a transport destination, after the busbar unit 22 and the electrode terminals 12A and 12B of the power storage devices 11 have been welded to each other.

Note that in the method of manufacturing the wiring module 20, the wire 21 may also be soldered in the process of soldering the chip fuse 47 and the like to the circuit board 40, and then the circuit board 40 to which the wire 21 is connected may be fixed to the busbar 30.

### Functions and Effects of Embodiment

According to the present embodiment, the following functions and effects are achieved.

According to the present embodiment, the wiring module 20 configured to be attached to a plurality of power storage devices 11 having electrode terminals 12A, 12B includes: a plurality of busbar units 22: and wires 21 connected to the busbar units 22, wherein each of the busbar units 22 includes: a busbar 30 connected to the electrode terminals 12A, 12B; a circuit board 40; and a fixing means 53 that fixes the circuit board 40 to the busbar 30, a conductive path 43 is routed on the circuit board 40, and the conductive path 43 includes: a connection land 45 electrically connected to the busbar 30; a wire land 46 connected to the corresponding wire 21; and a chip fuse 47 provided between the connection land 45 and the wire land 46.

With this configuration, since the circuit board 40 is fixed to the busbar 30, it is possible to reinforce the chip fuse 47 on the circuit board 40 with the busbar 30, eliminating the need of providing a member for protecting the chip fuse 47. Accordingly, it is possible to realize a simplified configuration of the wiring module 20 and reduce the manufacturing cost of the wiring module 20.

According to the present embodiment, the busbar 30 has a first fixation hole 34, the circuit board 40 has a second fixation hole 50, the fixing means 53 is a rivet 54 made of metal, the rivet 54 includes a shaft portion 55 inserted into the first fixation hole 34 and the second fixation hole 50, and a head portion 56 that is formed at an end of the shaft portion 55 and has a diameter greater than hole diameters of the first fixation hole 34 and the second fixation hole 50, and the circuit board 40 has an insulation hole 57 for increasing a creepage distance between the rivet 54 and the conductive path 43.

With this configuration, it is possible to fix the circuit board 40 to the busbar 30 with the rivet 54. Also, since the circuit board 40 has the insulation hole 57, the conductive path 43 and the busbar 30 are prevented from short-circuiting via the rivet 54 in response to melting of the chip fuse 47.

According to the present embodiment, the circuit board 40 has a drainage hole 58 capable of discharging water attached to the circuit board 40.

With this configuration, the conductive path 43 is prevented from short-circuiting via water on the circuit board 40.

According to the present embodiment, the connection between the chip fuse 47 and the conductive path 43 is sealed by a sealing part 49 made of a curable insulating resin, and the circuit board 40 has a resin retaining hole 59 for preventing the curable insulating resin that has not yet been cured and is liquid from spreading over the circuit board 40.

With this configuration, the sealing part 49 prevents the conductive path 43 from short-circuiting via water on the circuit board 40. Also, since the circuit board 40 has the resin retaining hole 59, the uncured liquid insulating resin enters the resin retaining hole 59, and thus is unlikely to spread over the circuit board 40.

According to the present embodiment, the busbar 30 includes a crimping part 36, 38 that fixes the wire 21.

With this configuration, it is possible to fix the wire 21 to the busbar 30 with the crimping part 36, 38.

According to the present embodiment, the circuit board 40 has a cutout 60 for preventing the circuit board 40 from interfering with the crimping part 36, 38.

With this configuration, it is possible to prevent a short-circuit between the conductive path 43 and the busbar 30.

According to the present embodiment, the circuit board 40 (circuit board 40A) of at least one of the busbar units 22 is a hard board 41.

With this configuration, it is possible to improve the strength of the circuit board 40. Also, it is possible to reduce the manufacturing cost of the wiring module 20.

According to the present embodiment, the circuit board 40 (circuit board 40B) of at least one of the busbar units 22 is a flexible board 62.

With this configuration, it is possible to realize a flexible circuit board 40. Also, it is possible to realize a thin circuit board 40.

According to the present embodiment, the flexible board 62 preferably includes a thermistor circuit 64.

With this configuration, it is possible to measure the temperature of the power storage devices 11 using the thermistor circuit 64.

The wiring module 20 according to the present embodiment is a vehicular wiring module 20 to be electrically attached to the plurality of power storage devices 11 mounted on a vehicle 1.

According to the present embodiment, the busbar unit 22 configured to be electrically connected to power storage devices 11 having electrode terminals 12A and 12B and to a wire 21 includes: a busbar 30 connected to the electrode terminals 12A and 12B; a circuit board 40; and a fixing means 53 that fixes the circuit board 40 to the busbar 30, a conductive path 43 is routed on the circuit board 40, and the conductive path 43 includes: a connection land 45 electrically connected to the busbar 30; a wire land 46 connected to the wire 21; and a chip fuse 47 provided between the connection land 45 and the wire land 46.

### Other Embodiments

(1) In the above-described embodiment, the fixing means 53 for fixing the circuit board 40 to the busbar 30 is the rivet 54, but the present invention is not limited to this. For example, a screw or an adhesive may be used as the fixing means.

(2) In the above-described embodiment, the connection between the chip fuse 47 and the conductive path 43 is configured to be sealed by the sealing part 49, but the present invention is not limited to this. A configuration is also possible in which a chip fuse is not sealed by a sealing part.

(3) In the above-described embodiment, the thermistor circuit 64 is provided, but the present invention is not limited to this. A configuration without any thermistor circuit is also possible.

### LIST OF REFERENCE NUMERALS

1: Vehicle
2: Power storage pack
3: PCU
4: Wire harness
10: Power storage module
11: Power storage device
12A, 12B: Electrode terminal
20: Wiring module
21: Wire
21A: Core wire
21B: Insulating coating
22, 22A, 22B: Busbar unit
30, 30A, 30B: Busbar
31: Busbar body
32: Electrode insertion hole
33: Circuit board arrangement portion
34: First fixation hole
35: Recess
36, 38: Crimping part
37: Positioning projection
40, 40A, 40B: Circuit board
41: Hard board
42: Insulating plate
43: Conductive path
44: Insulating layer
45: Connection land
45A: Small metal piece
46, 67: Wire land
47: Chip fuse
48: Electrode
49: sealing part
50: Second fixation hole
51: First through hole
52: Second through hole
53: Fixing means
54: Rivet
55: Shaft portion
56: Head portion
56A: Upper head portion
56B: Lower head portion
57: Insulation hole
58: Drainage hole
59: Resin retaining hole
60: Cutout
61: Positioning recess
62: Flexible board
63: Base film
64: Thermistor circuit
65: Thermistor
66: Thermistor conductive path
68: Reinforcing plate
68A: Reinforcing plate
69: Heat receiving portion
69A: Heat receiving plate
70: Extension portion
S: Solder

1. A wiring module configured to be attached to a plurality of power storage devices having electrode terminals, the wiring module comprising:
a plurality of busbar units: and
wires connected to the busbar units,
wherein each of the busbar units includes: a busbar connected to the electrode terminals; a circuit board; and a fixer that fixes the circuit board to the busbar,
a conductive path is routed on the circuit board, and
the conductive path includes: a connection land electrically connected to the busbar; a wire land connected to the corresponding wire; and a chip fuse provided between the connection land and the wire land, at least a part of the chip fuse being arranged at a position overlapping the busbar in a plan view.

2. The wiring module according to claim 1,
wherein the busbar has a first fixation hole,
the circuit board has a second fixation hole,
the fixer is a rivet made of metal,
the rivet includes a shaft portion inserted into the first fixation hole and the second fixation hole, and a head portion that is formed at an end of the shaft portion and has a diameter greater than hole diameters of the first fixation hole and the second fixation hole, and
the circuit board has an insulation hole for increasing a creepage distance between the rivet and the conductive path.

3. The wiring module according to claim 1,
wherein the circuit board has a drainage hole capable of discharging water attached to the circuit board.

4. The wiring module according to claim 1,
wherein the connection between the chip fuse and the conductive path is sealed by a sealing part made of a curable insulating resin, and
the circuit board has a resin retaining hole for preventing the curable insulating resin that has not yet been cured and is liquid from spreading over the circuit board.

5. The wiring module according to claim 1,
wherein the busbar includes a crimping part that fixes the corresponding wire.

6. The wiring module according to claim 5,
wherein the circuit board has a cutout for preventing the circuit board from interfering with the crimping part.

7. The wiring module according to claim 1,
wherein the circuit board of at least one of the busbar units is a hard board.

8. The wiring module according to claim 1,
wherein the circuit board of at least one of the busbar units is a flexible board.

9. The wiring module according to claim 8,
wherein the flexible board includes a thermistor circuit.

10. The wiring module according to claim 1,
wherein the wiring module is a vehicular wiring module to be electrically attached to the plurality of power storage devices mounted on a vehicle.

11. A busbar unit configured to be electrically connected to power storage devices having electrode terminals and to a wire, the busbar unit comprising:
a busbar connected to the electrode terminals; a circuit board; and a fixer that fixes the circuit board to the busbar,
wherein a conductive path is routed on the circuit board, and
the conductive path includes: a connection land electrically connected to the busbar; a wire land connected to the wire; and a chip fuse provided between the connection land and the wire land, at least a part of the chip fuse being arranged at a position overlapping the busbar in a plan view.
